(19) United States
(12) Patent Application Publication
(10) Pub. No.: US 2019/0122785 A1
(43) Pub. Date: Apr. 25, 2019

(54) MINERAL INSULATED POWER CABLES FOR ELECTRIC MOTOR DRIVEN INTEGRAL COMPRESSORS

(71) Applicant: SHELL OIL COMPANY, HOUSTON, TX (US)

(72) Inventors: David Booth BURNS, Houston, TX (US); Edward Everett DE ST. REMEY, Sugar Land, TX (US); Robert Guy HARLEY, Spring, TX (US); Alexei TCHERNIAK, Houston, TX (US)

(21) Appl. No.: 16/163,272

(22) Filed: Oct. 17, 2018

Related U.S. Application Data
(60) Provisional application No. 62/574,244, filed on Oct. 19, 2017.

(51) Int. Cl. H01B 7/02; F04D 25/06; F04D 17/10; H01B 9/00; H02K 5/10

(52) U.S. Cl. CPC H01B 7/02; F04D 25/0693; H02K 5/10; H01B 9/00; F04D 17/10

(57) ABSTRACT

A compressor system comprising a compressor and a mineral insulated cable, wherein the mineral insulated cable provides power to the compressor.

### TECHNICAL FIELD OF THE INVENTION

The present disclosure relates generally to power cables for electric motor driven integral compressors. More specifically, in certain embodiments, the present disclosure relates to the use of mineral insulated cables to supply power at medium voltage levels for electric motor driven integral compressors and associated systems.

### BACKGROUND OF THE INVENTION

In oil and gas fields, compressors are often used to maintain or increase gas flow in pipelines. Compressors may also be used to re-inject gas into reservoirs for reservoir pressure maintenance purposes. Examples of compressors that may be used for such purposes are electric motor driven integral compressors. Such compressors are described in U.S. Pat. No. 7,156,627.

These compressors often comprise an electric driven motor that is installed inside the compressor and is in direct contact with the gas being compressed. As these compressors are electric, power must be supplied to the motor of the compressor. This may be problematic when flammable gases are being compressed.

Conventionally, shielded polymeric insulated cables are utilized to supply electrical power to the motors of these compressors. These polymeric insulated cables require appropriate feed-through systems in order to safely function. These feed-through systems often include pour-seal type fittings, the use of a vented junction box to provide positive isolation between pressurized flammable material and the electrical distribution wiring, and the use of combustible gas detection to detect building up of flammable materials within the electrical junction box.

The use of these shielded polymeric cables requires a major capital expenditure to install and rely on multiple layers of detection equipment to determine if a flammable leak has occurred.

It is desirable to develop a cable for supplying electrical power to electric motor driven integral compressors that does not require major capital expenditure or rely on multiple layers of detection equipment to determine if a flammable leak has occurred.

### SUMMARY OF THE INVENTION

The present disclosure relates generally to power cables for electric motor driven integral compressors. More specifically, in certain embodiments, the present disclosure relates to the use of mineral insulated cables to supply power at medium voltage levels for electric motor driven integral compressors and associated systems.

In one embodiment, the present application provides a compressor system comprising: an electric motor driven integral compressor and a mineral insulated cable, wherein the mineral insulated cable provides power to the electric motor driven integral compressor.

### BRIEF DESCRIPTION OF THE FIGURES

A more complete and thorough understanding of the present embodiments and advantages thereof may be acquired by referring to the following description taken in conjunction with the accompanying drawings.

FIG. 1 is an illustration of a compressor system.

FIG. 2 is an illustration of an example of a power cable.

The features and advantages of the present disclosure will be readily apparent to those skilled in the art. While numerous changes may be made by those skilled in the art, such changes are within the spirit of the disclosure.

### DETAILED DESCRIPTION OF THE DRAWINGS

The description that follows includes exemplary apparatuses, methods, techniques, and/or instruction sequences that embody techniques of the inventive subject matter. However, it is understood that the described embodiments may be practiced without these specific details.

The present disclosure relates generally to power cables for electric motor driven integral compressors. More specifically, in certain embodiments, the present disclosure relates to the use of mineral insulated cables to supply power at medium voltage levels for electric motor driven integral compressors and associated systems.

Some desirable attributes of the systems and cables described herein is that they may serve as a replacement for the shielded polymeric insulated cables and systems utilizing those cables, eliminating the need for complicated feed-through fittings, the components associated with the use of polymeric insulated cables in classified areas, specially designed vented junction boxes and air terminal chambers, and sophisticated flammable gas monitoring systems. The use of mineral insulated cables for this application takes advantage of the inherent properties of the cable design high temperature withstand capability, the extremely low permeability of the MgO insulation and the high dielectric strength of the medium voltage mineral insulated cable design. As the mineral insulated cable design incorporates a corrosion resistant metallic sheath, its use also eliminates the need for corrosion resistant metallic conduits to protect the internal wiring feeding electrical power to the compressor.

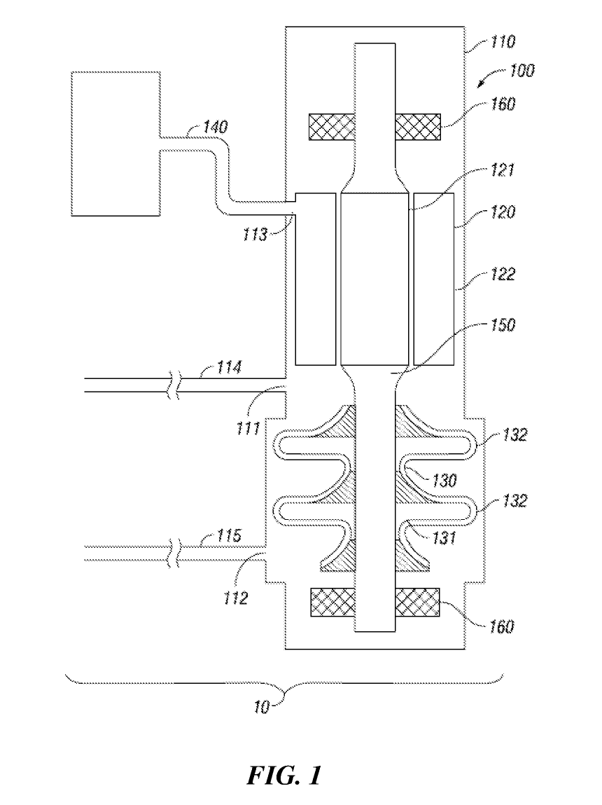

In certain embodiments, the present disclosure provides a compressor system. Referring now to FIG. 1, FIG. 1 illustrates compressor system 10. In certain embodiments, compressor system 10 may comprise compressor 100. In certain embodiments, compressor 100 may comprise an electric motor driven integral compressor. In certain embodiments, compressor 100 may be capable of compressing a flammable gas. In certain embodiments, compressor 100 may be used to maintain or increase the gas flow in a pipeline or may be used to re-inject gas into a reservoir. In certain embodiments, compressor 100 may comprise a medium voltage power connection.

In certain embodiments, compressor 100 may comprise housing 110, electric motor 120, compressor 130, and/or power cable 140.

In certain embodiments, housing 110 may comprise gas inlet 111, gas outlet 112, and power supply inlet 113. In certain embodiments, electric motor 120 and/or compressor 130 may be disposed within housing 110. In certain embodiments, housing 110 may comprise a gas tight housing. In certain embodiments, gas inlet 111 may be connected to gas line 114. In certain embodiments, not illustrated in FIG. 1, gas line 114 may be connected to a gas production header. In certain embodiments, gas outlet 112 may be connected to gas line 115. In certain embodiments, not illustrated in FIG. 1, gas line 115 may be connected to a gas export line or a gas injection facility.

In certain embodiments, motor 120 may comprise an electric motor. In certain embodiments, motor 120 may be disposed within housing 110. In certain embodiments, motor 120 may comprise rotor 121 and stator 122. In certain embodiments, stator 122 may be capable of driving rotor 121 when power is supplied to motor 120. In certain embodiments, power cable 140 may supply power to motor 120. In certain embodiments, motor 120 may be located inside compressor 100 and be exposed to flammable gases being compressed within housing 110.

In certain embodiments, rotor 121 may be connected to shaft 150. In certain embodiments, rotor 121 may be capable of driving shaft 150. In certain embodiments, shaft 150 may be in contact with one or more bearings 160. In certain embodiments, shaft 150 may be connected to impeller rotor 131. In certain embodiments, one or more impellers 132 may be disposed on impeller rotor 131. In certain embodiments, one, two, three, four, five or six impellers 132 may be disposed on impeller rotor 131. In certain embodiments, one or more impellers 132 may be located inside compressor 100 and be exposed to flammable gases being compressed within housing 110.

In certain embodiments, rotor 121, impeller rotor 131, and shaft 150 may comprise a single unit. In certain embodiments, impellers 132 may be an integral part of shaft 150.

In certain embodiments, power cable 140 may comprise a mineral insulated cable. In certain embodiments, power cable 140 may comprise a medium voltage mineral insulated cable. In certain embodiments, power cable 140 may be arranged in a single phase or a three-phase configuration. In certain embodiments, power cable 140 may be used as a power feed to motor 120.

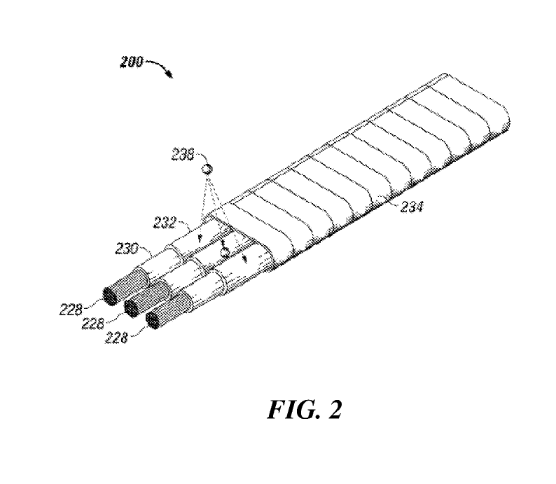

Referring now to FIG. 2, FIG. 2 illustrates mineral insulated cable 200. In certain embodiments, mineral insulated cable 200 may comprise one or more electrical conductors 238. In certain embodiments, mineral insulated cable 200 may comprise one, two, three, four, or six individual single electrical conductors 238. In certain embodiments, as shown in FIG. 2, mineral insulated cable 200 may comprise three single electrical conductors 238. In other embodiments, not illustrated in FIG. 2, mineral insulated cable 200 may comprise only a single electrical conductor 238. In certain embodiments, mineral insulated cable 200 may comprise a single phase, single cable design, a single phase, dual cable design, or a three phase, three cable design. In certain embodiments, mineral insulated cable 200 may comprise a single electrical circuit or multiple electrical circuits.

In certain embodiments, each of the individual single electrical conductors 238 may comprise conductive cores 228, mineral insulation 230, and protective sheath 232. In certain embodiments, conductive cores 228 may comprise an electrically conductive material. In certain embodiments, conductive cores 228 may comprise copper or aluminum.

In certain embodiments, mineral insulation 230 may comprise a high temperature insulator material. In certain embodiments, mineral insulation 230 may comprise magnesium oxide (MgO) or some derivation thereof. In certain embodiments, mineral insulation 230 may be constructed of inorganic material to avoid damaging carbonization in high temperature and/or high pressure environments. In certain embodiments, mineral insulation 230 may surround conductive cores 228. In certain embodiments, mineral insulation 230 may be in direct contact with conductive cores 228.

In certain embodiments, protective sheath 232 may surround mineral insulation 230. In certain embodiments, protective sheath 232 may be in direct contact with mineral insulation 230. In certain embodiments, protective sheath 232 may comprise a material suited for protecting conductive core 228 in the environment in which it is deployed. For example, protective sheath 232 in the illustrated examples is constructed of a material that can provide physical protection to conductive core 228 in a compressor. In some instances, protective sheath 232 may be constructed of a metallic material such as without limitation, stainless steel, duplex stainless steel, nickel iron, 825, INCOLOY 800, MONEL, carbon steel, lead or the like. Protective sheath 232 may be a seam welded metal jacket or may have similar construction. In certain embodiments, protective sheath 232 may be constructed of inorganic material to avoid damaging carbonization in high temperature and/or high pressure environments.

In certain embodiments, as shown in FIG. 2, protective sheath 232 may be of unitary construction. In other embodiments, not illustrated in FIG. 2, protective sheath 232 may be constructed of multiple sheaths, e.g., an inner sheath and an outer sheath. In certain embodiments, the inner sheath and the outer sheath may be formed of the same or of different materials. In certain embodiments, when multiple sheaths are used, each sheath may be constructed of an inorganic material to avoid damaging carbonization in high temperature and/or high pressure environments.

In certain embodiments, mineral insulated cable 200 may further comprise outer jacket 234. In certain embodiments, outer jacket 234 may constructed of a metallic material such as without limitation, stainless steel, duplex stainless steel, nickel iron, 825, INCOLOY 800, MONEL, carbon steel, lead or the like. In certain embodiments, outer jacket 234 may be constructed out of a material that is corrosion resistant and temperature compatible. In certain embodiments, outer jacket 234 may surround each of the electrical conductors 238. In certain embodiments, each of the single electrical conductor 238 may be joined by spiraling the individual single electrical conductors in a helical fashion and/or wrapping with an outer jacket 234. The outer jacket 234 may provide additional corrosion resistance and protective sheath 232 may provide additional axial strength or vice versa. In other embodiments, for example when mineral insulated cable comprises only a single electrical conductor 238, mineral insulated cable 200 may not comprise an outer jacket.

In certain embodiments, as illustrated in FIG. 2, each of the individual single electrical conductors 238 are shown positioned and joined to form power cable 200 that has a planar shape. In other embodiments, not illustrated in FIG. 2, each of the individual single electrical conductors 238 may be positioned relative to each other in a non-planar shape, for example triangular or cylindrically shaped power cable 200.

In certain embodiments, mineral insulated cable 200 may be a high voltage, medium voltage, or low voltage cable.

Referring to FIG. 1, in certain embodiments cable 140 may comprise any combination of features of discussed above with respect to mineral insulated cable 200.

In certain embodiments, cable 140 may pass through power supply inlet 113 of housing 110 to connect to motor 120. In certain embodiments, cable 140 may provide a process seal for inlet 113. In certain embodiments, the process seal may prevent flammable gases from leaking out of housing 110 via inlet 113. In certain embodiments, the process seal may satisfy the requirement for electrical connection in flammable atmosphere, under pressure, are required by NFPA 70 (National Electrical Code).

In certain embodiments, a power source 170 may be used to supply power to cable 140. In certain embodiments, power source 170 may be variable voltage transformer, silicon controlled rectifier, or directly connected to a power source with a switching device.

In certain embodiments, compressor 100 may be capable of compressing gas.

In certain embodiments, the present disclosure provides a method of compressing gas comprising: providing a compressor system comprising compressor and a mineral insulated cable, wherein the mineral insulated cable provides power to the compressor; providing a stream of gas to the compressor; and compressing the gas. In certain embodiments, the compressor system may comprise any compressor system discussed above.

From the foregoing, detailed description of specific embodiments, it should be apparent that a system for supplying power to an electric compressor utilizing a mineral insulated cable that is novel has been disclosed. Although specific embodiments have been disclosed herein in some detail, this has been done solely for the purposes of describing various features and aspects and is not intended to be limiting with respect to the scope of the claims herein. It is contemplated that various substitutions, alterations, and/or modifications, including but not limited to those implementation variations which may have been suggested herein, may be made to the disclosed embodiments without departing from the spirit and scope of the appended claims which follow.

What is claimed is:

1. A compressor system comprising a compressor and a mineral insulated cable, wherein the mineral insulated cable provides power to the compressor.

2. The compressor system of claim 1, wherein the compressor comprises an electric motor driven integral compressor.

3. The compressor system of claim 1, wherein the compressor comprises a housing, an electric motor disposed within the housing, and a compressor disposed within the housing,

4. The compressor system of claim 3, wherein the mineral insulated cable is connected to the electric motor.

5. The compressor system of claim 3, wherein the housing comprises a gas tight housing.

6. The compressor system of claim 3, wherein the housing comprises a gas inlet, a gas outlet, and a power supply inlet.

7. The compressor system of claim 6, wherein the gas inlet is connected to a first gas line and the gas outlet is connected to a second gas line.

8. The compressor system of claim 1, wherein the mineral insulated cable comprises one or more electrical conductors.

9. The compressor system of claim 8, wherein each of the one or more electric conductors comprise a conductive core surrounded by a mineral insulation.

10. The compressor system of claim 6, wherein the mineral insulated cable provides a process seal across the power supply inlet.
